(19) United States
(12) Patent Application Publication
(10) Pub. No.: US 2025/0391879 A1
(43) Pub. Date: Dec. 25, 2025

(54) POSITIVE ELECTRODE FOR ALL-SOLID-STATE RECHARGEABLE BATTERY AND ALL-SOLID-STATE RECHARGEABLE BATTERY

(71) Applicant: SAMSUNG SDI CO., LTD., Yongin-si, Gyeonggi-do (KR)

(72) Inventors: Mijung JUNG, Yongin-si, Gyeonggi-do (KR); Seonhyeok AN, Yongin-si, Gyeonggi-do (KR); Seunghyun OH, Yongin-si, Gyeonggi-do (KR)

(73) Assignee: SAMSUNG SDI CO., LTD., Yongin-si, Gyeonggi-do (KR)

(21) Appl. No.: 18/880,446

(22) PCT Filed: Jun. 26, 2023
(86) PCT No.: PCT/KR2023/008849

§ 371 Date: Dec. 31, 2024

(30) Foreign Application Priority Data
Sep. 16, 2022 (KR) 10-2022-0117365

(51) Int. Cl. H01M 4/62; H01M 4/131; H01M 10/052

(52) U.S. Cl. CPC H01M 4/628; H01M 4/131; H01M 4/623; H01M 10/052

(57) ABSTRACT

Disclosed are a positive electrode for an all-solid-state rechargeable battery, and an all-solid-state rechargeable battery including the same, the positive electrode including a current collector, and a positive electrode active material layer on the current collector, wherein the positive electrode active material layer includes a positive electrode active material, sulfide-based solid electrolyte, a fluorine-based resin binder, and vanadium oxide.

### TECHNICAL FIELD

Positive electrodes for all-solid-state rechargeable batteries and all-solid rechargeable batteries are disclosed.

### BACKGROUND ART

Recently, as the risk of explosion of a battery using a liquid electrolyte has been reported, development of an all-solid-state rechargeable battery has been actively conducted. An all-solid-state rechargeable battery refers to a battery in which all materials are solid, and in particular, a battery using a solid electrolyte. This all-solid-state rechargeable battery is safe with no risk of explosion due to leakage of the electrolyte and also easily prepared into a thin battery.

The positive electrode of an all-solid-state rechargeable battery is generally manufactured by coating a positive electrode composition including a positive electrode active material, a solid electrolyte, a binder, etc., on a current collector and drying it. At this time, fluorine-based resin binders are widely used as binders. However, the positive electrode composition becomes strongly alkaline due to residual lithium such as LiOH and other components, which may cause gelation of the fluorine-based resin binder. If gelation of the binder occurs, a viscosity of the positive electrode composition rapidly increases, which may lead to a situation where the process cannot proceed any further and the positive electrode composition must be discarded.

To prevent the gelation problem of these fluorine-based resin binders, there are methods of using non-fluorinated binders or adding neutralizing agents such as organic acids. However, non-fluorinated binders have the disadvantages of being inferior in terms of economy and oxidation resistance. In addition, a solid electrolyte, for example, a sulfide-based solid electrolyte, is introduced together with the positive electrode for an all-solid-state rechargeable battery. However, if a neutralizing agent is used in the positive electrode composition, there is a problem that (i) the neutralizing agent or (ii) moisture generated after neutralization may deteriorate the sulfide-based solid electrolyte.

### DISCLOSURE

The present invention provides a positive electrode for an all-solid-state rechargeable battery, which can maintain the viscosity of a positive electrode composition to secure processability by suppressing gelation of a fluorine-based resin binder while using the positive electrode, and an all-solid-state rechargeable battery including the positive electrode, which can improve the performance of the battery by preventing deterioration of a sulfide-based solid electrolyte in the positive electrode.

In an embodiment, a positive electrode for an all-solid-state rechargeable battery includes a current collector and a positive electrode active material layer on the current collector, wherein the positive electrode active material layer includes a positive electrode active material, a sulfide-based solid electrolyte, a fluorine-based resin binder, and vanadium oxide.

In another embodiment, an all-solid-state rechargeable battery includes the positive electrode and a negative electrode, and a solid electrolyte layer between the positive electrode and the negative electrode.

The positive electrode for an all-solid-state rechargeable battery according to an embodiment suppresses gelation of the fluorine-based resin binder while including the fluorine-based resin binder, thereby maintaining the viscosity of the positive electrode composition and ensuring processability. In addition, deterioration of a sulfide-based solid electrolyte in the positive electrode is prevented, thereby maintaining the ionic conductivity of the battery and improving the overall battery performance.

### DESCRIPTION OF THE DRAWINGS

FIGS. 1 and 2 are cross-sectional views schematically showing all-solid-state rechargeable batteries according to an embodiment.

### BEST MODE

Hereinafter, specific embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present invention. The singular expression includes the plural expression unless the context clearly dictates otherwise.

As used herein, “combination thereof” means a mixture, a laminate, a composite, a copolymer, an alloy, a blend, a reaction product, and the like of the constituents.

Here, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

In addition, the average particle diameter may be measured by a method well known to those skilled in the art, for example, may be measured by a particle size analyzer, or may be measured by a transmission electron microscope photograph or a scanning electron microscope photograph. Alternatively, it is possible to obtain an average particle diameter value by measuring it using a dynamic light scattering method, performing data analysis, counting the number of particles for each particle size range, and calculating from this. The average particle diameter may be measured by a microscope image or a particle size analyzer, and may mean a diameter (D50) of particles having a cumulative volume of 50 volume % in a particle size distribution.

Here, “or” is not to be construed as an exclusive meaning, for example, “A or B” is construed to include A, B, A+B, and the like.

### Positive Electrode for All-Solid-State Rechargeable Battery

In an embodiment, a positive electrode for an all-solid-state rechargeable battery includes a current collector and a positive electrode active material layer on the current collector, wherein the positive electrode active material layer includes a positive electrode active material, a sulfide-based solid electrolyte, a fluorine-based resin binder, and vanadium oxide.

The positive electrode for an all-solid-state rechargeable battery is manufactured by coating a positive electrode composition including a positive electrode active material, a sulfide-based solid electrolyte, a fluorine-based resin binder, and vanadium oxide on a current collector, and then drying and compressing.

The positive electrode composition generally has strong alkalinity due to residual lithium such as LiOH or other components, and thus gelation or coagulation of the fluorine-based resin binder may occur. However, according to an embodiment, by adding vanadium oxide, gelation of the fluorine-based resin binder may be suppressed, thereby maintaining the viscosity of the positive electrode composition and ensuring processability. In addition, because there is no need to use a neutralizer, etc., deterioration of the sulfide-based solid electrolyte due to the neutralizing agent can be prevented, thereby improving the performance of the all-solid-state rechargeable battery.

### Vanadium Oxide

The vanadium oxide is a component that does not dissolve in the solvent of the positive electrode composition, and can control the strong basicity of the positive electrode composition to prevent gelation of the fluorine-based resin binder, while at the same time suppressing deterioration of the sulfide-based solid electrolyte, thereby improving the ionic conductivity of the positive electrode. The vanadium oxide is understood to control the pH through physical and/or chemical reactions with —OH groups in the positive electrode composition in a strongly basic state, thereby suppressing gelation of the fluorine-based resin binder. The vanadium oxide has a more excellent ability to control basicity and suppress gelation of a fluorine-based resin binder than other transition metal oxides such as titanium oxide or tungsten oxide, has low reactivity with a sulfide-based solid electrolyte, and suppresses deterioration of the sulfide-based solid electrolyte, thereby improving the ionic conductivity of an all-solid-state rechargeable battery and enhancing its overall performance.

The vanadium oxide may include, for example, V₂O₃, VO₂, V₂O₄, V₂O₅, or a combination thereof. Additionally, the vanadium oxide may be included in an amount of 0.01 wt % to 5 wt %, for example, 0.05 wt % to 5 wt %, 0.1 wt % to 5 wt %, 0.5 wt % to 5 wt %, or 0.5 wt % to 3 wt % based on 100 wt % of the positive electrode active material layer. When the vanadium oxide is included in such a content, the viscosity of the positive electrode composition can be appropriately maintained without a decrease in capacity, thereby improving the processability and enhancing the ionic conductivity of the positive electrode.

According to an embodiment, because the positive electrode composition is coated on a current collector while vanadium oxide is dispersed by introducing vanadium oxide into the positive electrode composition, the vanadium oxide may be dispersed within the manufactured positive electrode active material layer. This is different from the form in which vanadium oxide is coated on the surface of the positive electrode active material or sulfide-based solid electrolyte.

In one example, the vanadium oxide may be pentavalent vanadium oxide (vanadium (V) oxide), in which case a melting point of the vanadium oxide may be less than or equal to 1000° C., for example, 600° C. to 800° C., or 650° C. to 690° C. The pentavalent vanadium oxide is excellent in suppressing gelation of the fluorine-based resin binder in the positive electrode and is advantageous in improving the overall performance of the battery.

Additionally, the vanadium oxide may be in the form of particles and may have an average particle diameter (D50) of 10 nm to 10 μm, for example 10 nm to 5 μm, 10 nm to 3 μm, 50 nm to 1 μm, 50 nm to 500 nm, or 500 nm to 1 μm. The vanadium oxide having these properties is suitable for introduction into a positive electrode composition and can effectively suppress gelation of the positive electrode composition without adversely affecting the positive electrode. If the particle size of vanadium oxide is too small, it may not be properly dispersed within the positive electrode, blocking the passage of electrons and ions, which may result in reduced battery performance, or it may not be able to sufficiently perform its role of suppressing binder gelation. Conversely, if the particle size of vanadium oxide is too large, it may block the passage of electrons and ions, which may reduce the performance of the battery.

### Fluorine-Based Resin Binder

The fluorine-based resin binder may be a general resin binder including fluorine, and may include, for example, polyvinylidene fluoride, a polyvinylidene fluoride-hexafluoropropylene copolymer, a polyvinylidene fluoride-trichloroethylene copolymer, a polyvinylidene fluoride-chlorotrifluoroethylene copolymer, polytetrafluoroethylene, or a combination thereof.

A weight average molecular weight of the above fluorine-based resin binder may be approximately 50 kDa to 5,000 kDa, or 100 kDa to 2,000 kDa. In addition, a glass transition temperature of the fluorine-based resin binder may be less than or equal to −10° C., and a melting point may be greater than or equal to 100° C. A melting viscosity of the fluorine-based resin binder may be about 10 kP to 50 kP. Additionally, the fluorine-based resin binder may be in the form of particles and may have an average particle diameter of approximately 50 nm to 200 μm. The fluorine-based resin binder having these properties can implement excellent adhesive strength even when added in a small amount to a positive electrode composition, and can increase the durability of the battery without adversely affecting battery performance.

The fluorine-based resin binder may be included in an amount of 0.1 wt % to 10 wt %, for example, 0.1 wt % to 8 wt %, 0.1 wt % to 6 wt %, 0.1 wt % to 5 wt %, 0.5 wt % to 4 wt %, or 1 wt % to 3 wt % based on 100 wt % of the positive electrode active material layer. When the fluorine-based resin binder is included in the above content range, excellent adhesive strength can be exhibited without adversely affecting the positive electrode.

### Positive Electrode Active Material

The positive electrode active material may be applied without limitation as long as it is generally used in all-solid-state rechargeable batteries. For example, the positive electrode active material may be a compound being capable of intercalating and deintercalating lithium, and may include a compound represented by one of the following chemical formulas.
LiₐA_{1-b}X_{b}D₂ (0.90≤a≤1.8, 0≤b≤0.5);
LiₐA_{1-b}X₆O_{2-c}D_{c} (0.90≤a≤1.8, 0≤b≤0.5, 0≤c≤0.05);
LiₐE_{1-b}X_{b}O_{2-c}D_{c} (0.90≤a≤1.8, 0≤b≤0.5, 0≤c≤0.05);
LiₐE_{2-b}X_{b}O_{4-c}D_{c} (0.90≤a≤1.8, 0≤b≤0.5, 0≤c≤0.05);
LiₐNi_{1-b-c}CO_{b}X_{c}D_{α} (0.90≤a≤1.8, 0≤b≤0.5, 0≤c≤0.5, 0<α≤2);
LiₐNi_{1-b-c}CO_{b}X_{c}O_{2-α}T_{α} (0.90≤a≤1.8, 0≤b≤0.5, 0≤c≤0.05, 0<α<2);
LiₐNi_{1-b-c}CO_{b}X_{c}O_{2-α}T_{α} (0.90≤a≤1.8, 0≤b≤0.5, 0≤c≤0.05, 0<α<2);
LiₐNi_{1-b-c}Mn_{b}X_{c}D_{α} (0.90≤a≤1.8, 0≤b≤0.5, 0≤c≤0.05, 0<α≤2);
LiₐNi_{1-b-c}Mn_{b}X_{c}CO_{2-α}T_{α} (0.90≤a≤1.8, 0≤b≤0.5, 0≤c≤0.05, 0<α<2);
LiₐNi_{1-b-c}Mn_{b}X_{c}O_{2-α}T₂ (0.90≤a≤1.8, 0≤b≤0.5, 0≤c≤0.05, 0<α<2);
LiₐNi_{b}E_{c}GₑO₂ (0.90≤a≤1.8, 0≤b≤0.9, 0≤c≤0.5, 0.001≤d≤0.1);
LiₐNi_{b}Co_{c}Mn_{d}GₑO₂ (0.90≤a≤1.8, 0≤b≤0.9, 0≤c≤0.5, 0≤d≤0.5, 0.001≤e≤0.1);
LiₐNiG_{b}O₂ (0.90≤a≤1.8, 0.001≤b≤0.1);
LiₐCoG_{b}O₂ (0.90≤a≤1.8, 0.001≤b≤0.1);
LiₐMn_{1-b}G_{b}O₂ (0.90≤a≤1.8, 0.001≤b≤0.1);
LiₐMn₂G_{b}O₄ (0.90≤a≤1.8, 0.001≤b≤0.1);
LiₐMn_{1-g}G_{g}PO₄ (0.90≤a≤1.8, 0≤g≤0.5);
QO₂; QS₂; LiQS₂;
V₂O₅; LiV₂O₅;
LiZO₂;
LiNiVO₄;
Li_{(3-f)}J₂(PO₄)₃ (0≤f≤2);
Li_{(3-f)}Fe₂(PO₄)₃ (0≤f≤2); and
LiₐFePO₄ (0.90≤a≤1.8).

In the chemical formulas, A is selected from Ni, Co, Mn, and a combination thereof; X is selected from Al, Ni, Co, Mn, Cr, Fe, Mg, Sr, V, rare earth elements, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The positive electrode active material may be, for example, a lithium cobalt oxide (LCO), a lithium nickel oxide (LNO), a lithium nickel cobalt oxide (NC), a lithium nickel cobalt aluminum oxide (NCA), a lithium nickel cobalt manganese oxide (NCM), a lithium nickel manganese oxide (NM), a lithium manganese oxide (LMO), or lithium iron phosphate (LFP).

The positive electrode active material may include lithium nickel-based oxide represented by Chemical Formula 1, lithium cobalt-based oxide represented by Chemical Formula 2, a lithium iron phosphate-based compound represented by Chemical Formula 3, or a combination thereof.

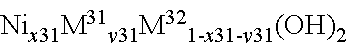

In Chemical Formula 1, 0.9≤a1≤1.8, 0.3≤x1≤1, 0≤y1≤0.7, and M¹ and M² are each independently one or more elements selected from Al, B, Ba, Ca, Ce, Co, Cr, Cu, F, Fe, Mg, Mn, Mo, Nb, P, S, Si, Sr, Ti, V, W, and Zr.

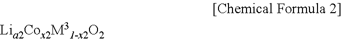

In Chemical Formula 2, 0.9≤a2≤1.8, 0.6≤x2≤1, and M³ is one or more elements selected from Al, B, Ba, Ca, Ce, Cr, Cu, F, Fe, Mg, Mn, Mo, Nb, P, S, Si, Sr, Ti, V, W, and Zr.

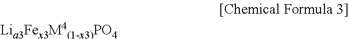

In Chemical Formula 3, 0.9≤a3≤1.8, 0.6≤x3≤1, M⁴ is one or more elements selected from Al, B, Ba, Ca, Ce, Co, Cr, Cu, F, Fe, Mg, Mn, Mo, Nb, P, S, Si, Sr, Ti, V, W, and Zr.

An average particle diameter (D50) of the positive electrode active material may be 1 μm to 25 μm, for example 3 μm to 25 μm, 5 μm to 25 μm, 5 μm to 20 μm, 8 μm to 20 μm, or 10 μm to 18 μm. The positive electrode active material having this particle size range can be harmoniously mixed with other components within the positive electrode active material layer and can achieve high capacity and high energy density.

The positive electrode active material may be in the form of secondary particles made by agglomerating a plurality of primary particles or in the form of single particles. Additionally, the positive electrode active material may have a spherical or close to spherical shape, or may have a polyhedral or irregular shape.

### Sulfide-Based Solid Electrolyte

The sulfide-based solid electrolyte may include, for example Li₂S—P₂S₅, Li₂S—P₂S₅—LiX (wherein X is a halogen element, for example I, or CI), Li₂S—P₂S₅-Li₂O, Li₂S—P₂S₅—Li₂O-LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZₘSₙ (wherein m and n is each an integer and Z is Ge, Zn, or Ga), Li₂S-GeS₂, Li₂S—SiS₂—LisPO₄, Li₂S—SiS₂—LiₚMO_{q} (wherein p and q each an integer and M is P, Si, Ge, B, Al, Ga, or In), or a combination thereof.

The sulfide-based solid electrolyte may be obtained by, for example, mixing Li₂S and P₂S₅ in a molar ratio of 50:50 to 90:10 or 50:50 to 80:20 and optionally, performing heat treatment. Within the mixing ratio range, a sulfide-based solid electrolyte having excellent ionic conductivity may be prepared. Here, other components such as SiS₂, GeS₂, and B₂S₃ may be added to further improve the ionic conductivity.

Mechanical milling or solution method may be applied as a mixing method of sulfur-containing raw materials for preparing a sulfide-based solid electrolyte. The mechanical milling is to make starting materials into particulates by putting the starting materials and ball mills in a reactor and fervently stirring them. The solution method may be performed by mixing the starting materials in a solvent to obtain a solid electrolyte as a precipitate. In addition, in the case of heat treatment after mixing, crystals of the solid electrolyte may be more robust and ionic conductivity may be improved. For example, the sulfide-based solid electrolyte may be prepared by mixing sulfur-containing raw materials and performing heat treatment two or more times. In this case, a sulfide-based solid electrolyte having high ionic conductivity and robustness may be prepared.

For example, the sulfide-based solid electrolyte particles may include argyrodite-type sulfide. The argyrodite-type sulfide may be represented by, for example, a chemical formula of LiₐM_{b}P_{c}S_{d}Aₑ (wherein a, b, c, d, and e are all 0 or more and 12 or less, M is Ge, Sn, Si, or a combination thereof, and A is F, Cl, Br, or I), and as a specific example, may be represented by a chemical formula of Li₇₋ₓPS₆₋ₓAₓ (wherein x is 0.2 or more and 1.8 or less, and A is F, Cl, Br, or I). The argyrodite-type sulfide may specifically be Li₃PS₄, Li₂P₃S₁₁, Li₂PS₆, Li₆PS₅Cl, Li₆PS₅Br, Li_{5.8}PS_{4.8}Cl_{1.2}, Li_{6.2}PS_{5.2}Br_{0.8}, etc.

The sulfide-based solid electrolyte particles including such an argyrodite-type sulfide-based solid electrolyte may have high ionic conductivity close to the range of 10⁻⁴ to 10⁻² S/cm, which is the ionic conductivity of general liquid electrolytes at room temperature, and may form an intimate bond between the positive electrode active material and the solid electrolyte without causing a decrease in ionic conductivity, and furthermore, an intimate interface between the electrode layer and the solid electrolyte layer. An all-solid-state battery including this can have improved battery performances such as rate capability, coulombic efficiency, and cycle-life characteristics.

The argyrodite-type sulfide-based solid electrolyte may be prepared, for example, by mixing lithium sulfide and phosphorus sulfide, and optionally lithium halide. Heat treatment may be performed after mixing them. The heat treatment may include, for example, two or more heat treatment steps.

An average particle diameter (D50) of the sulfide-based solid electrolyte particles according to an embodiment may be less than or equal to 5.0 μm, for example, 0.1 μm to 5.0 μm, 0.1 μm to 4.0 μm, 0.1 μm to 3.0 μm, 0.5 μm to 2.0 μm, or 0.1 μm to 1.5 μm. The sulfide-based solid electrolyte particles may be small particles with an average particle diameter (D50) of 0.1 μm to 1.0 μm or may be large particles with an average particle diameter (D50) of 1.5 μm to 5.0 μm depending on the location or purpose of use. The sulfide-based solid electrolyte particles having this particle size range can effectively penetrate between solid particles in a battery, and have excellent contact with an electrode active material and connectivity between solid electrolyte particles. The average particle diameter of the sulfide-based solid electrolyte particles may be measured using a microscope image, and for example, a particle size distribution may be obtained by measuring the size of about 20 particles in a scanning electron microscope image, and D50 may be calculated therefrom.

A content of the solid electrolyte in the positive electrode for the all-solid-state battery may be 0.5 wt % to 35 wt %, for example 1 wt % to 35 wt %, 5 wt % to 30 wt %, 8 wt % to 25 wt %, or 10 wt % to 20 wt %. This is a content based on a total weight of the components in the positive electrode, and specifically, it may be referred to as a content based on a total weight of the positive electrode active material layer.

In an embodiment, the positive electrode active material layer may include 50 wt % to 99.35 wt % of the positive electrode active material, 0.5 wt % to 35 wt % of the sulfide-based solid electrolyte, 0.1 wt % to 10 wt % of the fluorine-based resin binder, and 0.05 wt % to 5 wt % of vanadium oxide, based on 100 wt % of the positive electrode active material layer. When the content range is satisfied, the positive electrode for an all-solid-state rechargeable battery can realize high capacity and high ionic conductivity while maintaining high adhesive strength, and the viscosity of the positive electrode composition can be maintained at an appropriate level, thereby improving processability.

### Conductive Material

The positive electrode active material layer may further include a conductive material. The conductive material is used to impart conductivity to the electrode, and may include for example a carbon-based material such as natural graphite, artificial graphite, carbon black, acetylene black, ketjen black, a carbon fiber, a carbon nanotube, and the like; a metal-based material containing copper, nickel, aluminum, silver and the like and in the form of a metal powder or a metal fiber; a conductive polymer such as a polyphenylene derivative; or a combination thereof.

The conductive material may be included in an amount of 0.1 wt % to 5 wt %, or 0.1 wt % to 3 wt % based on a total weight of each component of the positive electrode for an all-solid-state battery or a total weight of the positive electrode active material layer. In the above content range, the conductive material may improve electrical conductivity without degrading battery performance.

When the positive electrode active material layer further includes a conductive material, the positive electrode active material layer may include 45 wt % to 99.25 wt % of the positive electrode active material, 0.5 wt % to 35 wt % of the sulfide-based solid electrolyte, 0.1 wt % to 10 wt % of the fluorine-based resin binder, 0.05 wt % to 5 wt % of vanadium oxide, and 0.1 wt % to 5 wt % of the conductive material, based on 100 wt % of the positive electrode active material layer.

Meanwhile, the positive electrode for a rechargeable lithium battery may further include an oxide-based inorganic solid electrolyte in addition to the aforementioned solid electrolyte. The oxide-based inorganic solid electrolyte may include for example Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr, Ti)O₃ (PZT), Pb₁₋ₓLaₓZr_{1-y}Ti_{y}O₃ (PLZT) (0≤x<1, 0≤y<1), PB(Mg₃Nb_{2/3})O₃₋PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (LisPO₄), lithium titanium phosphate (LiₓTl_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂— based ceramics, Garnet-based ceramics Li₃₊ₓLa₃M₂O₁₂ (wherein M=Te, Nb, or Zr; and x is an integer of 1 to 10), or a combination thereof.

### All-Solid-State Rechargeable Battery

In an embodiment, an all-solid-state rechargeable battery includes the aforementioned positive electrode and negative electrode and a solid electrolyte layer between the positive electrode and negative electrode. The all-solid-state rechargeable battery may also be expressed as an all-solid-state battery or an all-solid-state lithium rechargeable battery.

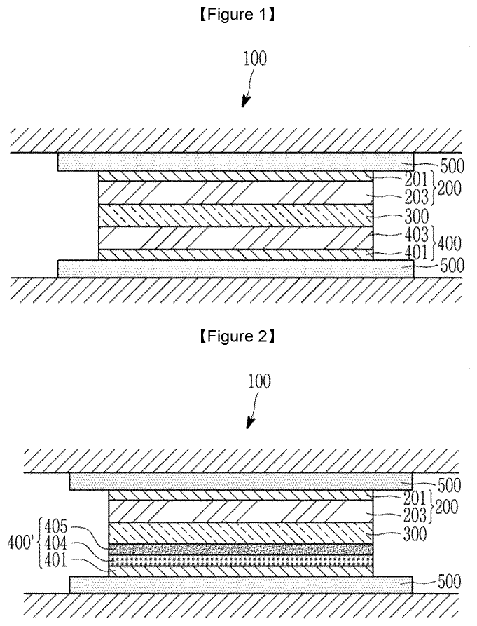

FIG. 1 is a cross-sectional view of an all-solid-state battery according to an embodiment. Referring to FIG. 1, the all-solid-state battery 100 may have a structure that an electrode assembly, in which a negative electrode 400 including a negative electrode current collector 401 and a negative electrode active material layer 403, a solid electrolyte layer 300, and a positive electrode 200 including a positive electrode active material layer 203 and a positive electrode current collector 201 are stacked, is inserted into a case such as a pouch and the like. The all-solid-state battery 100 may further include at least one elastic layer 500 on the outside of at least either one of the positive electrode 200 and the negative electrode 400. FIG. 4 shows one electrode assembly including the negative electrode 400, the solid electrolyte layer 300, and the positive electrode 200, but two or more electrode assemblies may be stacked to manufacture an all-solid-state battery.

### Negative Electrode

A negative electrode for an all-solid-state battery may include, for example, a current collector and a negative electrode active material layer on the current collector. The negative electrode active material layer includes a negative electrode active material and may further include a binder, a conductive material, and/or a solid electrolyte.

The negative electrode active material may include a material capable of reversibly intercalating/deintercalating lithium ions, lithium metal, an alloy of lithium metal, a material capable of doping and dedoping lithium, or a transition metal oxide.

The material capable of reversibly intercalating/deintercalating lithium ions may include, for example crystalline carbon, amorphous carbon, or a combination thereof as a carbon-based negative electrode active material. The crystalline carbon may be irregular, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy may include an alloy of lithium and one or more metal selected from Na, K, Rb, Cs, Fr, Be, Mg, Ca, Sr, Si, Sb, Pb, In, Zn, Ba, Ra, Ge, Al, and Sₙ.

The material capable of doping/dedoping lithium may be a Si-based negative electrode active material or a Sₙ-based negative electrode active material. The Si-based negative electrode active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sₙ-based negative electrode active material may include Sₙ, SnO₂, a Sₙ—R alloy (wherein R is an alkali metal, an alkaline-earth metal, a Group 13 element, a Group 14 element, a Group 15 element, a Group 16 element, a transition metal, a rare earth element, and a combination thereof, but not Sₙ). At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

The silicon-carbon composite may be, for example, a silicon-carbon composite including a core including crystalline carbon and silicon particles and an amorphous carbon coating layer disposed on the surface of the core. The crystalline carbon may be artificial graphite, natural graphite, or a combination thereof. The amorphous carbon precursor may be a coal-based pitch, mesophase pitch, petroleum-based pitch, coal-based oil, petroleum-based heavy oil, or a polymer resin such as a phenol resin, a furan resin, or a polyimide resin. In this case, the content of silicon may be 10 wt % to 50 wt % based on the total weight of the silicon-carbon composite. In addition, the content of the crystalline carbon may be 10 wt % to 70 wt % based on the total weight of the silicon-carbon composite, and the content of the amorphous carbon may be 20 wt % to 40 wt % based on the total weight of the silicon-carbon composite. In addition, a thickness of the amorphous carbon coating layer may be 5 nm to 100 nm.

The average particle diameter (D50) of the silicon particles may be 10 nm to 20 μm, for example, 10 nm to 500 nm. The silicon particles may be present in an oxidized form, and at this time, an atomic content ratio of Si:O in the silicon particle indicating a degree of oxidation may be 99:1 to 33:67. The silicon particles may be SiOₓ particles, and in this case, the range of x in SiOₓ may be greater than 0 and less than 2. The average particle diameter (D50) may be measured by a microscope image or a particle size analyzer, and may mean a diameter (D50) of particles having a cumulative volume of 50 volume % in a particle size distribution.

The Si-based negative electrode active material or Sₙ-based negative electrode active material may be used by mixing with a carbon-based negative electrode active material. The mixing ratio of the Si-based negative electrode active material or Sₙ-based negative electrode active material and the carbon-based negative electrode active material may be 1:99 to 90:10 by weight.

In the negative electrode active material layer, the negative electrode active material may be included in an amount of 95 wt % to 99 wt % based on the total weight of the negative electrode active material layer.

In an embodiment, the negative electrode active material layer further includes a binder and may optionally further include a conductive material. A content of the binder in the negative electrode active material layer may be 1 wt % to 5 wt % based on the total weight of the negative electrode active material layer. In addition, when further including a conductive material, the negative electrode active material layer may include 90 to 98 wt % of the negative electrode active material, 1 to 5 wt % of the binder, and 1 to 5 wt % of the conductive material.

The binder serves to attach the negative electrode active material particles well to each other and also to attach the negative electrode active material well to the current collector. The binder may include a water-insoluble, a water-soluble binder, or a combination thereof.

The water-insoluble binder may include, for example polyvinylchloride, carboxylated polyvinylchloride, polyvinylfluoride, an ethylene oxide-containing polymer, ethylene propylene copolymer, polystyrene, polyvinylpyrrolidone, polyurethane, polytetrafluoroethylene, polyvinylidene fluoride, polyethylene, polypropylene, polyamideimide, polyimide, or a combination thereof.

The water-soluble binder may include a rubber-based binder or a polymer resin binder. The rubber-based binder may be selected from a styrene-butadiene rubber, an acrylated styrene-butadiene rubber, an acrylonitrile-butadiene rubber, an acrylic rubber, a butyl rubber, a fluorine rubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a thickener capable of imparting viscosity may be used together, and the thickener may include, for example, a cellulose-based compound. The cellulose-based compound may include carboxymethyl cellulose, hydroxypropylmethyl cellulose, methyl cellulose, an alkali metal salt thereof, or a combination thereof. The alkali metal may be Na, K, or Li. The amount of the thickener used may be 0.1 parts by weight to 3 parts by weight based on 100 parts by weight of the negative electrode active material.

The conductive material is used to provide conductivity to the electrode, and may include, for example, carbon-based materials such as natural graphite, artificial graphite, carbon black, acetylene black, ketjen black, a carbon fiber, and a carbon nanotube; a metal-based material in the form of metal powder or metal fibers, including copper, nickel, aluminum, and silver; a conductive polymer such as a polyphenylene derivative; or mixtures thereof.

The negative electrode current collector may include one selected from a copper foil, a nickel foil, a stainless steel foil, a titanium foil, a nickel foam, a copper foam, a polymer substrate coated with a conductive metal, and a combination thereof.

As another example, the negative electrode for the all-solid-state battery may be a precipitation-type negative electrode. The precipitation-type negative electrode means a negative electrode that does not include a negative electrode active material when the battery is assembled, but in which lithium metal or the like is precipitated when the battery is charged and this acts as a negative electrode active material.

FIG. 2 is a schematic cross-sectional view of an all-solid-state battery including a precipitation-type negative electrode. Referring to FIG. 2, the precipitation-type negative electrode 400′ may include a current collector 401 and a negative electrode catalyst layer 405 on the current collector. In an all-solid-state battery having such a precipitation-type negative electrode 400′, initial charging begins in the absence of a negative electrode active material, and when charging, a high-density lithium metal or the like is precipitated between the current collector 401 and the negative electrode catalyst layer 405 to form a lithium metal layer 404, which can serve as a negative electrode active material. Accordingly, in an all-solid-state battery that has been charged more than once, the precipitation-type negative electrode 400′ may include a current collector 401, a lithium metal layer 404 on the current collector, and a negative electrode catalyst layer 405 on the metal layer. The lithium metal layer 404 refers to a layer in which lithium metal, etc. is precipitated during the charging process of the battery, and may be referred to as a metal layer or a negative electrode active material layer.

The negative electrode catalyst layer 405 may include a metal, a carbon material, or a combination thereof that acts as a catalyst.

The metal may include, for example, gold, platinum, palladium, silicon, silver, aluminum, bismuth, tin, zinc, or a combination thereof, and may be composed of one of these or various types of alloys. If the metal is present in particle form, an average particle diameter (D50) thereof may be less than or equal to 4 μm, for example, 10 nm to 4 μm.

The carbon material may be, for example, crystalline carbon, amorphous carbon, or a combination thereof. The crystalline carbon may be for example natural graphite, artificial graphite, mesophase carbon microbeads, or a combination thereof. The amorphous carbon may be for example carbon black, activated carbon, acetylene black, denka black, ketjen black, or a combination thereof.

If the negative electrode catalyst layer 405 includes the metal and the carbon material, the metal and the carbon material may be, for example, mixed in a weight ratio of 1:10 to 2:1. Here, the precipitation of the lithium metal may be effectively promoted and improve characteristics of the all-solid-state battery. The negative electrode catalyst layer 405 may include, for example, a carbon material on which a catalyst metal is supported or a mixture of metal particles and carbon material particles.

The negative electrode catalyst layer 405 may include, for example, the metal and amorphous carbon, in which case it can effectively promote the precipitation of lithium metal.

The negative electrode catalyst layer 405 may further include a binder, and the binder may be a conductive binder. Additionally, the negative electrode catalyst layer 405 may further include general additives such as a filler, a dispersant, an ion conductive agent, and the like.

A thickness of the negative electrode catalyst layer 405 may be for example 100 nm to 20 μm, 500 nm to 10 μm, or 1 μm to 5 μm.

The precipitation-type negative electrode 400′ may further include a thin film, for example, on the surface of the current collector, that is, between the current collector and the negative electrode catalyst layer. The thin film may include an element capable of forming an alloy with lithium. The element capable of forming an alloy with lithium may be, for example, gold, silver, zinc, tin, indium, silicon, aluminum, bismuth, and the like, which may be used alone or an alloy of more than one. The thin film may further planarize a precipitation shape of the lithium metal layer 404 and much improve characteristics of the all-solid-state battery. The thin film may be formed, for example in a vacuum deposition method, a sputtering method, a plating method, and the like. The thin film may have, for example, a thickness of 1 nm to 500 nm.

### Solid Electrolyte Layer

The solid electrolyte layer 300 may include a sulfide-based solid electrolyte, an oxide-based solid electrolyte, etc. Details of the sulfide-based solid electrolyte and the oxide-based solid electrolyte are as described above.

In one example, the solid electrolyte included in the positive electrode 200 and the solid electrolyte included in the solid electrolyte layer 300 may include the same compound or different compounds. For example, when both the positive electrode 200 and the solid electrolyte layer 300 include an argyrodite-type sulfide-based solid electrolyte, overall performance of the all-solid-state rechargeable battery may be improved. In addition, for example, when both the positive electrode 200 and the solid electrolyte layer 300 include the aforementioned coated solid electrolyte, the all-solid-state rechargeable battery may implement excellent initial efficiency and cycle-life characteristics while implementing high capacity and high energy density.

Meanwhile, the average particle diameter (D50) of the solid electrolyte included in the positive electrode 200 may be smaller than the average particle diameter (D50) of the solid electrolyte included in the solid electrolyte layer 300. In this case, the energy density of the all-solid-state battery may be maximized while increasing the mobility of lithium ions to improve the overall performance. For example, the average particle diameter (D50) of the solid electrolyte included in the positive electrode 200 may be 0.1 μm to 1.0 μm, or 0.1 μm to 0.8 μm and the average particle diameter (D50) of the solid electrolyte included in the solid electrolyte layer 300 may be 1.5 μm to 5.0 μm, or 2.0 μm to 4.0 μm, or 2.5 μm to 3.5 μm. If these particle size ranges are satisfied, the energy density of the all-solid-state rechargeable battery may be maximized while the transfer of lithium ions is facilitated, thereby suppressing resistance and improving the overall performance of the all-solid-state rechargeable battery. Here, the average particle diameter (D50) of the solid electrolyte can be measured using a particle size analyzer using laser diffraction. Alternatively, about 20 particles may be arbitrarily selected from a micrograph of a scanning electron microscope or the like, the particle size is measured, and a particle size distribution is obtained, and the D50 value may be calculated.

The solid electrolyte layer may further include a binder in addition to the solid electrolyte. At this time, a styrene butadiene rubber, polytetrafluoroethylene, polyvinylidene fluoride, polyethylene, an acrylate polymer, or a combination thereof can be used as a binder, but is not limited thereto, and any binder used in the relevant technical field can be used. The acrylate polymer may be, for example, butyl acrylate, polyacrylate, polymethacrylate, or a combination thereof.

The solid electrolyte layer may be formed by adding a solid electrolyte to a binder solution, coating the same on a base film, and drying. The solvent of the binder solution may be isobutyryl isobutyrate, xylene, toluene, benzene, hexane, or a combination thereof. Because the solid electrolyte layer formation process is widely known in the art, a detailed description thereof will be omitted. A thickness of the solid electrolyte layer may be, for example, 10 μm to 150 μm.

The solid electrolyte layer may further include an alkali metal salt, and/or an ionic liquid, and/or a conductive polymer.

For example, the alkali metal salt may be lithium salt. The content of lithium salt in the solid electrolyte layer may be greater than or equal to 1 M or for example 1 M to 4 M. In this case, the lithium salt may improve ionic conductivity by improving lithium ion mobility in the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato) borate (LiBOB), lithium oxalyldifluoroborate (LIODFB), lithium difluoro (oxalato) borate (LiDFOB), lithium bis(trifluoro methanesulfonyl)imide (LiTFSI, LiN(SO₂CF₃)₂), lithium bis(fluorosulfonyl)imide (LiFSI, LiN(SO₂F)₂), LiCF₃SO₃, LiAsF₆, LiSbF₆, LiClO₄, or a mixture thereof.

In addition, the lithium salt may be an imide-based lithium salt, and for example, the imide-based lithium salt may include lithium bis(trifluoro methanesulfonyl)imide (LiTFSI, LiN(SO₂CF₃)₂), lithium bis(fluorosulfonyl)imide (LiFSI, LiN(SO₂F)₂). The lithium salt can maintain or improve ionic conductivity by maintaining appropriate chemical reactivity with ionic liquid.

The ionic liquid has a melting point below room temperature, so it is in a liquid state at room temperature and refers to a salt or room temperature molten salt composed of ions alone.

The ionic liquid may be a compound including a) at least one cation selected from ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, or triazolium-based cation, and a mixture thereof, and b) at least one anion selected from BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, (FSO₂)₂N—, (C₂F₅SO₂)₂N—, (C₂FsSO₂)(CF₃SO₂)N—, and (CF₃SO₂)₂N—.

The ionic liquid may be, for example, one or more selected from N-methyl-N-propylpyrrolidinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be 0.1:99.9 to 90:10, for example 10:90 to 90:10, 20:80 to 90:10, 30:70 to 90:10, 40:60 to 90:10, or 50:50 to 90:10. The solid electrolyte layer satisfying the above ranges may maintain or improve ionic conductivity by improving the electrochemical contact area with the electrode. Accordingly, the energy density, discharge capacity, rate capability, etc. of the all-solid-state battery may be improved.

An all-solid-state battery may be a unit cell with a structure of positive electrode/solid electrolyte layer/negative electrode, a bicell with a structure of positive electrode/solid electrolyte layer/negative electrode/solid electrolyte layer/positive electrode, or a stacked battery in which the structure of the unit cell is repeated.

The shape of the all-solid-state battery is not particularly limited, and may be, for example, coin-shaped, button-shaped, sheet-shaped, stacked-shaped, cylindrical, flat, etc. In addition, the all-solid-state battery may be applied to a large-sized battery used in an electric vehicle or the like. For example, the all-solid-state battery may also be used in hybrid vehicles such as plug-in hybrid electric vehicles (PHEV). In addition, it may be used in a field requiring a large amount of power storage, and may be used, for example, in an electric bicycle or a power tool.

### MODE FOR INVENTION

Hereinafter, examples and comparative examples of the present invention will be described. The following examples are only examples of the present invention and the present invention is not limited to the following examples.

### Example 1

### 1. Preparation of Positive Electrode Composition

A positive electrode composition is prepared by mixing 84.9 wt % of a positive electrode active material of LiNi_{0.945}Co_{0.04}Al_{0.015}O₂, 13.51 wt % of an argyrodite-type sulfide-based solid electrolyte of Li₆PS₅Cl, 1 wt % of a PVdF binder, 0.1 wt % of vanadium oxide (V₂O₅), 0.35 wt % of a carbon nanotube conductive material, and 0.14 wt % of hydrogenated nitrile butadiene rubber (HNBR) as a dispersant in an isobutyryl isobutyrate (IBIB) solvent.

### 2. Manufacturing of Positive Electrode

The prepared positive electrode composition is coated on the positive electrode current collector, dried, and then compressed (warm isostatic press (WIP), 500 MPa, 85° C., 30 min) to manufacture the positive electrode.

### 3. Manufacturing of Solid Electrolyte Layer

A composition for forming a solid electrolyte layer is prepared by adding and mixing an argyrodite-type solid electrolyte of Li₆PS₅Cl and an IBIB solvent including an acrylic binder. The composition is cast onto a releasing film and dried at room temperature to produce a solid electrolyte layer.

### 4. Manufacture of Negative Electrode

A catalyst is prepared by mixing carbon black having a primary particle diameter of about 30 nm and silver (Ag) having an average particle diameter (D50) of about 60 nm in a weight ratio of 3:1, and 0.25 g of the catalyst is added to 2 g of NMP solution including 7 wt % of polyvinylidene fluoride binder and mixed to prepare a negative electrode catalyst layer composition. This is coated onto a negative electrode current collector and then dried to prepare a precipitation-type negative electrode in which a negative electrode catalyst layer is formed on the current collector.

5. Manufacturing of all-Solid-State Rechargeable Battery Cell

The prepared positive electrode, negative electrode, and solid electrolyte layers are cut, the solid electrolyte layer is stacked on the positive electrode, and then the negative electrode is stacked thereon. This is sealed in a pouch shape and pressed at high temperature at 80° C. and 500 MPa for 30 minutes under warm isostatic pressure to manufacture an all-solid-state rechargeable battery cell.

### Examples 2 and 3 and Comparative Examples 1 to 3

A positive electrode and an all-solid-state rechargeable battery cell are manufactured in the same manner as in Example 1, except that the positive electrode composition is changed to the composition in Table 1.

TABLE 1

| | Comparative | | | Comparative | Comparative |
|---|---|---|---|---|---|
| | Example 1 | Example 1 | Example 2 | Example 2 | Example 3 |
| Vanadium oxide | 0 | 0.5 | 0.7 | 0 | 0 |
| Titanium oxide | 0 | 0 | 0 | 0.5 | 0 |
| Oxalic acid | 0 | 0 | 0 | 0 | 0.5 |
| Positive | 85 | 84.58 | 84.41 | 84.58 | 84.58 |
| electrode active | | | | | |
| material | | | | | |
| Solid electrolyte | 13.44 | 13.37 | 13.35 | 13.37 | 13.37 |
| Binder | 1 | 0.99 | 0.99 | 0.99 | 0.99 |
| Conductive | 0.4 | 0.4 | 0.39 | 0.4 | 0.4 |
| material | | | | | |
| Dispersant | 0.16 | 0.16 | 0.16 | 0.16 | 0.16 |

### Evaluation Example 1: Viscosity Analysis of Positive Electrode Composition

The change in viscosity of the positive electrode compositions of Examples 1 and 2 and Comparative Examples 1 to 3 was measured from immediately after preparation to 72 hours later, and the results are shown in Table 2. Here, the viscosity was measured as shear viscosity using a rotating rheometer (Model: Anton Paar MCR 302), and was measured at a shear rate of 10 s⁻¹ with a 50 mm parallel plate geometry, a gap size of 0.5 mm, and a rotational rheometer (Rotating Rheometer, Model: Anton Paar MCR 302). The unit of each data in Table 2 is mPa*s.

TABLE 2

| | Comparative | | | Comparative | Comparative |
|---|---|---|---|---|---|
| | Example 1 | Example 1 | Example 2 | Example 2 | Example 3 |
| Immediately | 4,342 | 2,784 | 2,130 | 3,442 | 2,086 |
| after | | | | | |
| manufacturing | | | | | |
| 24 hours later | 16,288 | 3,699 | 2,531 | 7,383 | 2,645 |
| 72 hours later | unmeasurable | 6,707 | 3,394 | 19,211 | 5,713 |

Referring to Table 2, in the case of Comparative Example 1, the viscosity increases by more than two times in just 24 hours after manufacturing the positive electrode composition. On the other hand, in the case of Examples, the viscosity increase was greatly reduced compared to Comparative Example 1, and accordingly, it was found that gelation of the fluorine-based binder was suppressed. It is thought that because the viscosity of the positive electrode composition is maintained, the processability can be improved and the battery performance can be enhanced. In addition, in the case of Comparative Example 2 using titanium oxide, the effect of suppressing gelation of the binder is not as good as in Examples. In the case of Comparative Example 3 using oxalic acid, the effect of suppressing gelation of the binder was shown to be good, but as in Evaluation Example 2, the solid electrolyte was found to deteriorate and the ionic conductivity was found to decrease, which will be explained in detail below.

### Evaluation Example 2: Evaluation of Ionic Conductivity and Electronic Conductivity

The ionic conductivity and electronic conductivity of the positive electrodes manufactured in Examples 1 and 2 and Comparative Examples 1 to 3 were measured, and the results are shown in Table 3. The positive electrodes manufactured in each of Examples and Comparative Examples were cut into 10 pi circles, and measurements were made while applying a torque of 10 N m to the positive electrodes, and the measurements were made through electrochemical impedance spectroscopy (EIS). EIS was performed at an amplitude of 50 mV, a frequency of 500 kHz to 50 mHz, in air, and at 45° C. The unit of each data in Table 3 is mS/cm.

TABLE 3

| | Comparative | | | Comparative | Comparative |
|---|---|---|---|---|---|
| | Example 1 | Example 1 | Example 2 | Example 2 | Example 3 |
| Ionic | 0.19 | 0.14 | 0.12 | 0.15 | 0.0048 |
| conductivity | | | | | |
| Electronic | 1.25 | 1.27 | 1.21 | 1.19 | 0.98 |
| conductivity | | | | | |

Referring to Table 3, Examples 1 and 2 exhibited ionic and electronic conductivities at levels almost equivalent to those of Comparative Example 1 without adding vanadium oxide. In the case of Comparative Example 3 where oxalic acid was added, although the gelation of the binder in Evaluation Example 1 was suppressed, the deterioration of the sulfide-based solid electrolyte was accelerated, resulting in a rapid decrease in ionic conductivity and also in an electronic conductivity.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

1. A positive electrode for an all-solid-state rechargeable battery, comprising
a current collector and a positive electrode active material layer on the current collector,
wherein the positive electrode active material layer includes a positive electrode active material, a sulfide-based solid electrolyte, a fluorine-based resin binder, and vanadium oxide.

2. The positive electrode for the all-solid-state rechargeable battery as claimed in claim 1, wherein
the vanadium oxide includes V₂O₃, VO₂, V₂O₄, V₂O₅, or a combination thereof.

3. The positive electrode for the all-solid-state rechargeable battery as claimed in claim 1, wherein
the vanadium oxide is included in an amount of 0.05 wt % to 5 wt % based on 100 wt % of the positive electrode active material layer.

4. The positive electrode for the all-solid-state rechargeable battery as claimed in claim 1, wherein
the vanadium oxide is dispersed within the positive electrode active material layer.

5. The positive electrode for the all-solid-state rechargeable battery as claimed in claim 1, wherein
an average particle size of the vanadium oxide is 10 nm to 10 μm.

6. The positive electrode for the all-solid-state rechargeable battery as claimed in claim 1, wherein
a softening point of the vanadium oxide is 650° C. to 690° C.

7. The positive electrode for the all-solid-state rechargeable battery as claimed in claim 1, wherein
the fluorine-based resin binder includes polyvinylidene fluoride, a polyvinylidene fluoride-hexafluoropropylene copolymer, a polyvinylidene fluoride-trichloroethylene copolymer, a polyvinylidene fluoride-chlorotrifluoroethylene copolymer, polytetrafluoroethylene, or a combination thereof.

8. The positive electrode for the all-solid-state rechargeable battery as claimed in claim 1, wherein
the fluorine-based resin binder is included in an amount of 0.1 wt % to 10 wt % based on 100 wt % of the positive electrode active material layer.

9. The positive electrode for the all-solid-state rechargeable battery as claimed in claim 1, wherein
the positive electrode active material includes a lithium cobalt oxide, a lithium nickel oxide, a lithium nickel cobalt oxide, a lithium nickel cobalt aluminum oxide, a lithium nickel cobalt manganese oxide, a lithium nickel manganese oxide, a lithium manganese oxide, lithium iron phosphate, or a combination thereof.

10. The positive electrode for the all-solid-state rechargeable battery as claimed in claim 1, wherein
the positive electrode active material includes a lithium nickel-based oxide represented by Chemical Formula 1, a lithium cobalt-based oxide represented by Chemical Formula 2, a lithium iron phosphate-based compound represented by Chemical Formula 3, or a combination thereof: 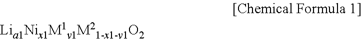
wherein, in Chemical Formula 1, 0.9≤a1≤1.8, 0.3≤x1≤1, 0≤y1≤0.7, and M¹ and M² are each independently one or more elements selected from Al, B, Ba, Ca, Ce, Co, Cr, Cu, F, Fe, Mg, Mn, Mo, Nb, P, S, Si, Sr, Ti, V, W, and Zr, 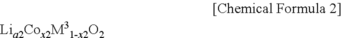
wherein, in Chemical Formula 2, 0.9<a2≤1.8, 0.6≤x2≤1, and M³ is one or more elements selected from Al, B, Ba, Ca, Ce, Cr, Cu, F, Fe, Mg, Mn, Mo, Nb, P, S, Si, Sr, Ti, V, W, and Zr, 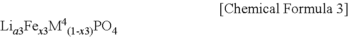
wherein, in Chemical Formula 3, 0.95a3≤1.8, 0.6≤x3≤1, and M⁴ is one or more elements selected from Al, B, Ba, Ca, Ce, Co, Cr, Cu, F, Fe, Mg, Mn, Mo, Nb, P, S, Si, Sr, Ti, V, W, and Zr.

11. The positive electrode for the all-solid-state rechargeable battery as claimed in claim 1, wherein
an average particle diameter (D50) of the positive electrode active material is 5 μm to 25 μm.

12. The positive electrode for the all-solid-state rechargeable battery as claimed in claim 1, wherein
the sulfide-based solid electrolyte includes argyrodite-type sulfide.

13. The positive electrode for the all-solid-state rechargeable battery as claimed in claim 12, wherein
the argyrodite-type sulfide includes Li₃PS₄, Li₂P₃S₁₁, Li₂PS₆, Li₆PS₅Cl, Li₆PS₅Br, Li_{5.8}PS_{4.8}Cl_{1.2}, Li_{6.2}PS_{5.2}Br_{0.8}, or a combination thereof.

14. The positive electrode for the all-solid-state rechargeable battery as claimed in claim 1, wherein
an average particle diameter (D50) of the sulfide-based solid electrolyte is 0.1 μm to 5.0 μm.

15. The positive electrode for the all-solid-state rechargeable battery as claimed in claim 1, wherein
an average particle diameter (D50) of the sulfide-based solid electrolyte is 0.1 μm to 2.0 μm.

16. The positive electrode for the all-solid-state rechargeable battery as claimed in claim 1, wherein
the positive electrode active material layer includes
50 wt % to 99.35 wt % of the positive electrode active material,
0.5 wt % to 35 wt % of the sulfide-based solid electrolyte,
0.1 wt % to 10 wt % of the fluorine-based resin binder, and
0.05 wt % to 5 wt % of the vanadium oxide based on 100 wt % of the positive electrode active material layer.

17. The positive electrode for the all-solid-state rechargeable battery as claimed in claim 1, wherein
the positive electrode active material layer further includes a conductive material, and
the positive electrode active material layer includes
45 wt % to 99.25 wt % of the positive electrode active material,
0.5 wt % to 35 wt % of the sulfide-based solid electrolyte,
0.1 wt % to 10 wt % of the fluorine-based resin binder,
0.05 wt % to 5 wt % of the vanadium oxide, and
0.1 wt % to 5 wt % of the conductive material based on 100 wt % of the positive electrode active material layer.

18. An all-solid-state rechargeable battery, comprising
the positive electrode as claimed in claim 1,
a negative electrode, and
a solid electrolyte layer between the positive electrode and the negative electrode.

19. The all-solid-state rechargeable battery as claimed in claim 18, wherein
the negative electrode includes a current collector and a negative electrode active material layer or negative electrode catalyst layer on the current collector.

20. The all-solid-state rechargeable battery as claimed in claim 18, wherein
the negative electrode includes a current collector and a negative electrode catalyst layer on the current collector, and
a lithium metal layer formed between the current collector and the negative electrode catalyst layer during initial charging.
